(19) United States
(12) Patent Application Publication
(10) Pub. No.: US 2006/0212408 A1
(43) Pub. Date: Sep. 21, 2006

(54) Framework and language for development of multimodal applications

(75) Inventors: Marcicalito Nuestro, Livermore, CA (US); Jayant Thomas, San Ramon, CA (US); John Tadlock, Austin, TX (US); David J. Silva, Gilberts, IL (US); Bruce Brenton, Manchester, MO (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/082,274

(22) Filed: Mar. 17, 2005

(51) Int. Cl. G06Q 99/00

(52) U.S. Cl. 705/74

(57) ABSTRACT

A method and apparatus provides a framework for specifying a multimodal application, such as an IVR, in a communication network. The framework provides a metalanguage that enables a programmer to specify a multimodal user interface using view logic, business rules using router logic, and integration with a backend enterprise system.

### BACKGROUND OF THE INVENTION

1. Field of the Invention

The present invention relates to the specification of business interactions performed between a business customer and an interactive machine. In particular, the present invention provides a method and apparatus that provides a framework and language for defining and providing a computerized interactive response between multimodal users and a business enterprise based on defined business rules.

2. Description of the Related Art

Interactive Voice Response (IVR) applications are often used to perform a business transaction with a caller over a telephonic connection without the need of the immediate presence of a business agent. In the past, IVRs have been developed using tools, programming languages, and Integrated Development Environments (IDEs) that have been provided by vendors and business enterprises to a telecommunications company which operates the IVR. These IDEs, tools, and languages generally provide a capability to develop and create three main aspects of a VRU (Voice Response Unit) application, namely a voice user interface, business logic, and backend integration with a business enterprise. The voice user interface provides a mode of communication between a customer (user) and an IVR application and provides a structured flow through a business service to complete a business transaction. Business logic generally comprises a set of states and a set of rules for making transitions between states in reaction to customer input. Backend integration enables information to flow back and forth between customer and business enterprises.

With the development of new technologies, such as the Internet and mobile phones having video displays, there come new possible modes of interaction between business and customer. A new generation of IVRs or equivalent interactive applications will need to address these new technologies and incorporate the new modes of interaction. Several issues arise when tools for IVR development are proprietary to the vendor. First of all, such IVR applications are generally platform-dependent and are not portable from one platform to another. Secondly, these IVR applications are generally not designed to implement business logic and enterprise code with web applications and other recent technologies. Thirdly, these IVR applications cannot, in general, be implemented as multimodal applications into the IVR. Multimodal applications represent a convergence of content—i.e., video, audio, text, images—with various modes of user interface interaction (web page, phone, etc.). Typically, multimodal interfaces provide for user input using speech, a keyboard, keypad, mouse and/or stylus. Output is typically in the form of synthesized speech, audio, plain text, motion video and/or graphics, etc.

Prior approaches to IVR development use one framework for creating the view components (which generate dialog to interact with customers) and another for developing the business logic components (state management rules for providing the business service). Thus, a different language is used creating the components that provide state management than for developing business logic. Often, view logic and business logic are tightly coupled and there is no clear separation of the two within the framework. Also, applications created using prior approaches are typically single-mode applications, so that they are either IVR-only or web-only applications.

Recently, there has been an effort to adopt a standard programming language for voice applications. Voice Extensible Markup Language, which is also referred to as VoiceXML or VXML, is a standard established by the World Wide Web Consortium (W3C) standards body. The current generation of VXML, VXML 2.0, provides a standard language that facilitates the interactions between human and machine that traditionally have been provided by voice response applications, such as IVRs.

VXML describes a human-machine interaction provided by voice response systems, which includes output of synthesized speech (text-to-speech), output of audio files, recognition of spoken input, recognition of DTMF input, recording of spoken input, control of dialog flow, and telephony features such as call transfer and disconnect. VXML provides means for collecting character and/or spoken input, assigning the input results to document-defined request variables, and making decisions that affect the interpretation of documents written in the language. A document may be linked to other documents through Universal Resource Identifiers (URIs).

VXML partially solves the portability problems of vendor-based IVR development by providing standards for basic IVR functions. VXML separates user interaction code (in VXML) from service logic (e.g. CGI scripts). But while VoiceXML strives to accommodate the requirements of a majority of voice response services, services with stringent requirements may best be served by dedicated applications that employ a finer level of control. Also, VXML is not intended for intensive computation, database operations, or legacy system operations. These are assumed to be handled by resources outside the document interpreter, e.g. a document server. General service logic, state management, dialog generation, and dialog sequencing are assumed to reside outside the document interpreter. VXML 2.0 does not address issues of IVR development such as the creation of services that provide business logic, the creation of services that provide backend integration, and the dynamic creation of dialog specification at runtime.

There is a need for a single framework that provides a standard method of creating platform independent services that provide business logic for the IVR and for other enterprise applications, e.g., web applications. Also, there is a need for a standard method of defining business rules within services that can be shared, used, and interpreted by any mode of user interface, be it speech (VXML), keyboard (HTML), or keypad (WML), etc. Also, there is a need for a standard method of defining view logic that can be used and interpreted by any mode of user interface, a standard method of accessing and using enterprise data to create services that provide enterprise business rules and logic, and a single methodology, language and environment that integrates the above requirements into one framework.

### SUMMARY OF THE INVENTION

The present invention provides a method and apparatus that provide a framework for specifying a multimodal application in a communication network. A framework is provided that defines a metalanguage that enables a programmer to specify an interactive application. The programmer can specify a multimodal user interface for user input to the interactive application. The programmer can specify business rules that act on a user input. The programmer can also specify an interface between the application and a business enterprise. The present invention enables a programmer to specify a multimodal user interface of the multimodal application that provides view logic for providing communication modes such as, a voice response unit, a textual web interface, or a video display. The response communication mode to the user can be automatically determined by the application and can be different from the input communication mode.

The business rules comprise business logic and generally enable transitions between states of a business service in response to user input. The programmer also specifies how the application interacts with a business enterprise system or database. Also, user input can be stored in a database associated with a business enterprise. The programmer specifies a response to the user input in accordance with the business rules to provide the multimodal application.

In one aspect of the present invention a computerized method and apparatus are provided for providing an application in a communication network. The method and apparatus provides for receiving a first programmer input specifying a user interface for a user communication with the application, receiving a second programmer input specifying a business rule in the application that acts on a user input from the user interface and receiving a third programmer input specifying an interaction between the application and an enterprise system. The user interface further comprises a view logic for a mutimodal communication mode. The multimodal communication mode further comprises at least one of the set consisting of a web browser and a cell phone. A metalanguage is provided to indicate a code segment to specify a view, action or routing to a new state in the application. The business rule provides at least one of the set consisting of a transition between states of a business service, and a transfer of information between the user and a database. The method further provides for specifying a first communication mode for the user input and specifying a second communication mode for a transmitting a response to the user.

In another aspect of the invention a set of application program interfaces are provided embodied on a computer readable medium for execution on a computer in conjunction with an application program in a communication network comprising a first interface that receives a first programmer input specifying a user interface for a user communication with the application, a second interface that receives a second programmer input specifying a business rule in the application that acts on a user input from the user interface and a third interface that receives a third programmer input specifying an interaction between the application and an enterprise system.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For a detailed understanding of the present invention, references should be made to the following detailed description of an exemplary embodiment, taken in conjunction with the accompanying drawings, in which like elements have been given like numerals.

FIG. 1 illustrates an apparatus suitable for implementing an example of the present invention;

FIG. 2 illustrates a state diagram representation of an exemplary multimodal application that can be implemented using an example of the present invention;

FIG. 3 illustrates an Application Server and various states of a business service in an example of the present invention;

FIG. 4 illustrates an exemplary interface for a typical software development interface of the example of the present invention;

FIG. 5 illustrates examples of software code corresponding to the entries in the software development interface of FIG. 4; and

FIG. 6 illustrates a flowchart by which the present invention provides a multimodal application in an example of the invention.

### DETAILED DESCRIPTION OF THE INVENTION

In view of the above, the present invention through one or more of its various aspects and/or embodiments is presented to provide one or more advantages, such as those noted below.

VWDF provides a single integrated framework that covers all aspects of a customer or user-oriented application. Only one framework is used for developing the view components, the business logic components and the data/system integration components of the application. The VWDF provides a single language and a single framework for defining the business logic, view logic and the data access logic for multimodal applications. With VWDF, there is clear separation of the view logic components and business logic components, while keeping the two within the same framework. It also performs computation, database operation and legacy systems operations for business rule interpretation within the single framework. Since the same language is used for developing any mode of user interface, it is a multimodal application.

Use of the VWDF improves the System Development Life Cycle by providing an enabling concurrent code development and a direct traceability of application code with the user specification and system requirement. Developers can work concurrently on different parts of the application without concern for being out of sync. Developers can assemble the states together at a later time, or they can even test the states running on each others machine by just pointing their routers to the machine of another. For example, Developer A located in Chicago can use the state defined components of Developer B located at St. Louis by merely using the URI of the component of Developer B.

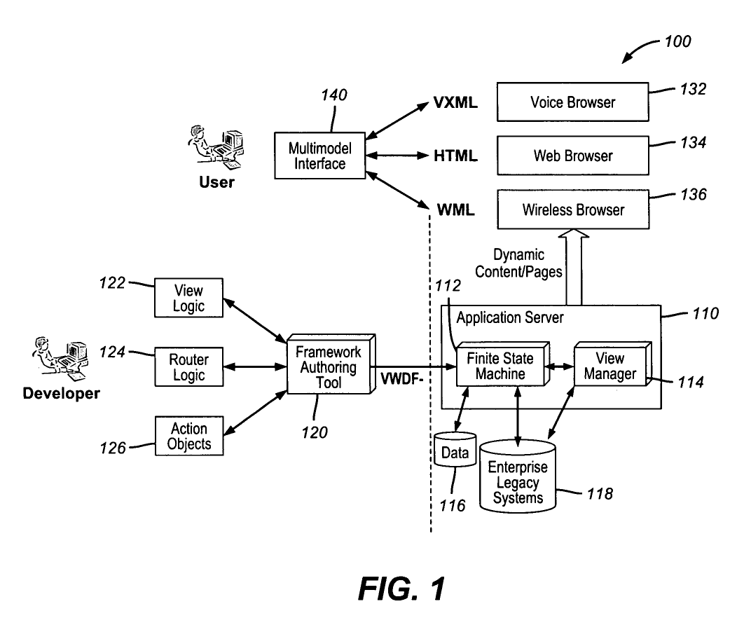

FIG. 1 illustrates a conceptual hardware implementation 100 for providing the present invention. The present example of the invention is presented as a Voice Web Development Framework (VWDF) that provides an open platform, single integrated environment and language for defining service logic, state management, dialog generation, and dialog sequencing for IVR, Web, or any multimodal application. FIG. 1 depicts the VWDF and shows how the different components of the application can be separated within a single framework. An Application Server 110 comprises a Finite State Machine 112 for implementing business logic and a View Manager 114 for providing business services to a customer. A Framework Authoring Tool 120 provides an interactive development environment through which a developer can supply logical code objects for implementation on the Application Server 110.

The Framework Authoring Tool comprises an interface to View Logic 120 for specifying user interface logic, Router Logic 122 for providing business rules and logic for transitioning to different states of an application, and Action Objects 124 which provide access to and integration with backend systems (i.e. database, legacy systems and business enterprises). VWDF provides a single metalanguage for defining the states that contain the view logic (the components that provide interaction with the user), the business logic (the component that contains the business rules for the application) and the systems and data access logic (the component that provides integration with enterprise legacy systems, e.g., database, customer management systems or ordering systems). The defined states are combined into a Finite State Machine which interacts with Data 116 and Enterprise Legacy Systems 118 to store and produce data usable in a customer interaction, i.e. billing information, address information, etc. The View Manager 114 interacts with the Finite State Machine and Enterprise Legacy Systems 118 and provides a mode for user interaction. The VWDF creates a system that interacts with a user in a communication mode appropriate to the user. For example, HTTP for web users and WAP for cell phone users.

Dynamic page content is provided from the Application Server to a user over a multimodal interface 140 using one of several possible modes. For example, a Voice Browser 132 enables a voice interaction using VXML code, a Web Browser 134 enables web interaction through HyperText Markup Language (HTML) code, or a Wireless Browser 136 enables an interaction using Wireless Markup Language (WML) code. Browsers may be accessed in a single mode or in a combination of modes. A user can interact with the Application Server using any available interface mode (cell phone, web, legacy telephone (plain ordinary telephone service—POTS)). The number of modes shown in the present invention is for illustrative purposes, and the number of interface modes is not limited to those modes listed herein.

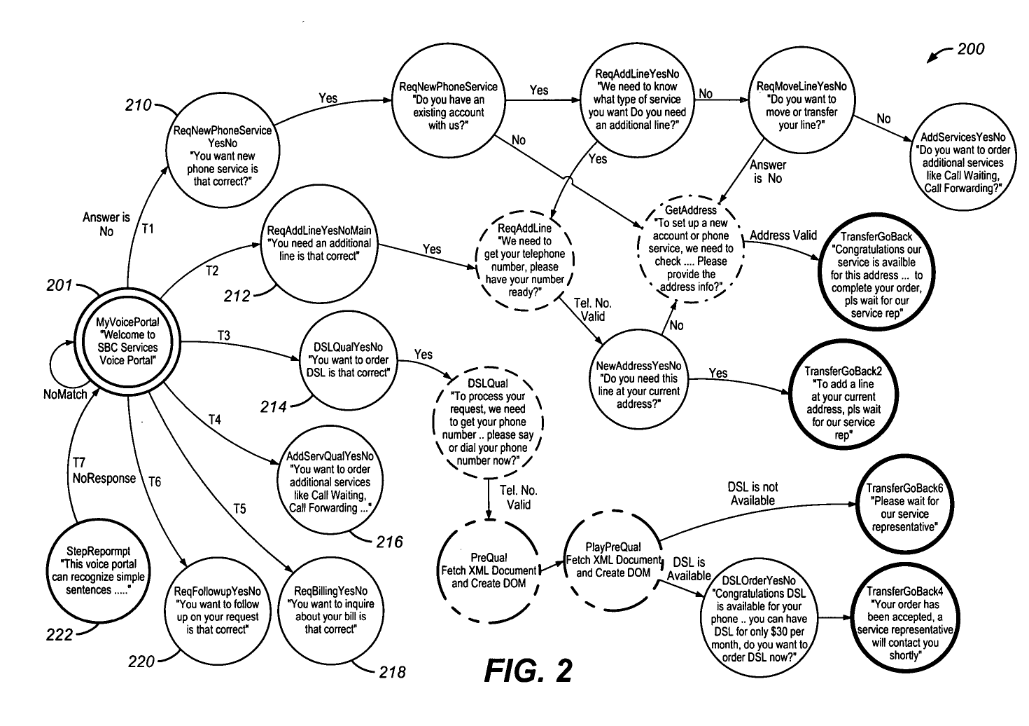

FIG. 2 illustrates a state diagram representation 200 of an exemplary voice response application that can be implemented using the present invention. VWDF uses a state model to represent a business application. The states may be defined in any language such as XML. The underlying language is hidden from the programmer specifying the states. The programmer uses the metalanguage provided instead of any particular vender or platform specific language. Each defined state is converted into real time objects on the Application Server 110. The resultant Finite State Machine model of the application is accessible through a mode of the multimodal user interface. Business logic determines the flow of the user through the state diagram 200 in response to user input. A user may “enter” the state diagram at 201 and transition to one of several accessible states based on the user response to a prompt by the Application Server. The example of FIG. 2 enables a customer to obtain a phone service from a telephone company. States accessible from state 201 enable a customer to obtain new phone service 210, to obtain an addition line 212, to order DSL (Digital Subscriber Line) service 214, to order additional services like Call Waiting, Call Forwarding, etc. 216, to inquire about a bill 218, and to follow up on a request 220. A reprompt state is activated if there is no user response within a set amount of time 222. If there is no match between a user response and available state selections, the user is returned to entry state 201. The state transition that is performed depends on the value of the user input.

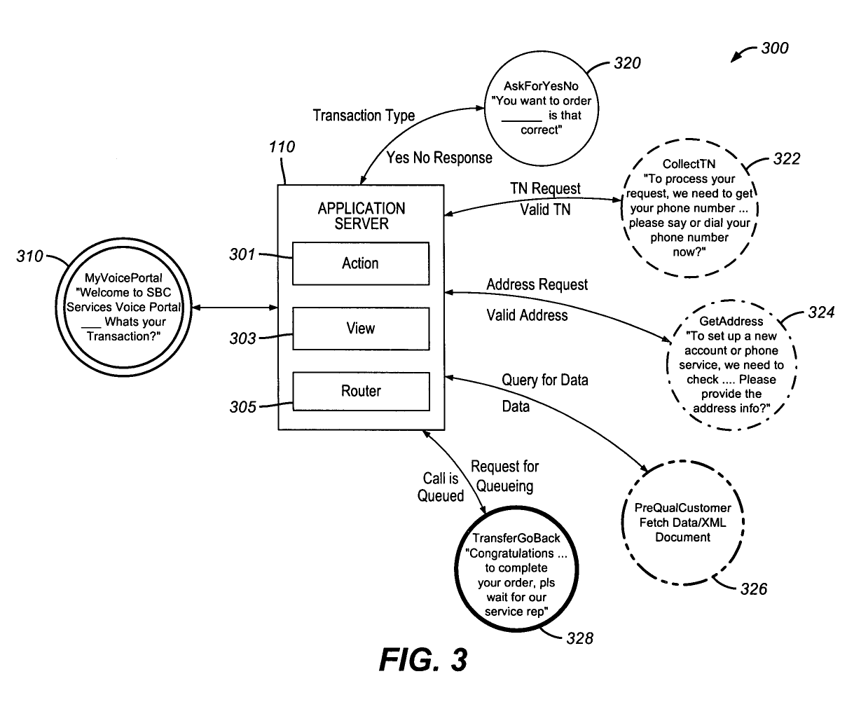

FIG. 3 illustrates an Application Server 110 and various states of a business service. Each state is implemented on the Application Server 300 and comprises View Logic 303 implementing a user interface, Router Logic 305 implementing rules for transitioning through business service, and system integration logic (Action) 301 providing access to a business enterprise. State 310 is a greeting for a customer and requests a customer to choose an option for proceeding. States perform a variety of functions from prompting a user for input and obtains a user response to obtaining accessing backend enterprise information. For example, state 320 prompts the user with the phrase “You want to order ______, is that correct?” and the user replies with either a “Yes” or a “No”. State 322 and state 324 gather information from a user. State 322 prompts the user for a telephone number, and receives a telephone number in response. State 324 prompts the user for an address and receives an address in response. State 326 obtains data from a database. Such information may indicate, for example, whether DSL service is available for a given telephone number or address. State 328 provides a confirmation to a user and places the user call in a queue.

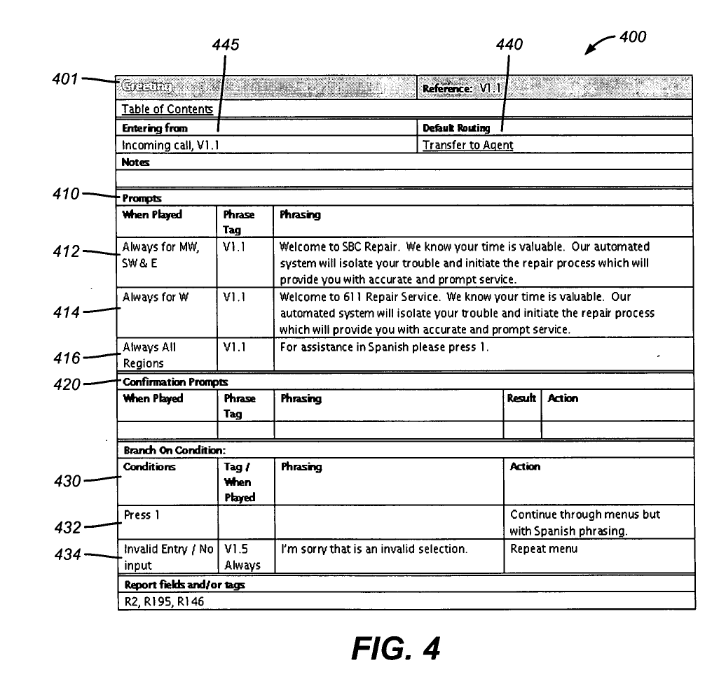

FIG. 4 illustrates an exemplary metalanguage interface 400 of the present example of the invention, VWDF for a software development interface. A title 401 (“Greeting”) for the state is displayed. The screen indicates a Default Routing state 440 (“Transfer to Agent”) and any prior states 445 from which the current state is accessed (e.g. “Incoming Call”). In the example, the “Greeting” state is activated by an incoming call. Sections 410 and 420 provide user prompts to be presented to a user in an interaction. Section 430 provides a set of branching conditions (business logic). A variety of phrases are presented in screen 400 corresponding to variations in location, language, etc. For instance, phrase 412 is presented to callers in Midwestern (MW), southwestern (SW), or eastern (E) regions.

An alternate phrase 414 is presented to users in the western (W) region. In all regions, phrase 416 (“For assistance in Spanish, please press 1”) is always played. Section 420 provides a set of confirmation responses to user input. Section 430 comprises a set of branching conditions providing instructions for state transitions in response to user input. For example, according to branching conditions 432, if the user presses “1” the application continues through the business logic using Spanish phrasing to interact with the user. If an invalid entry 434 is entered, the application tells the user “I'm sorry. That is an invalid selection.” and repeats the menu.

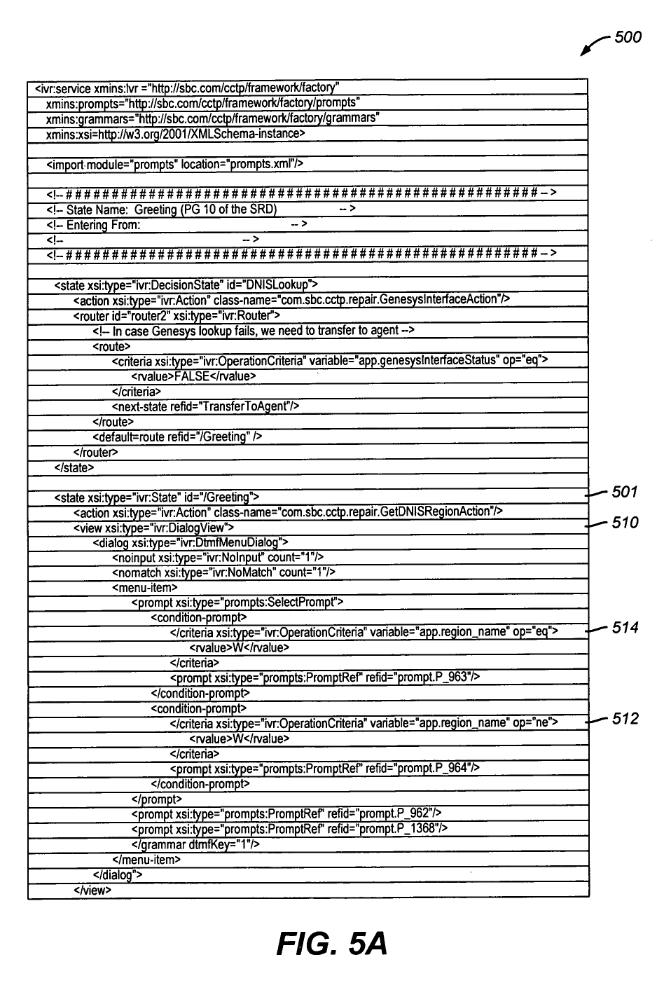

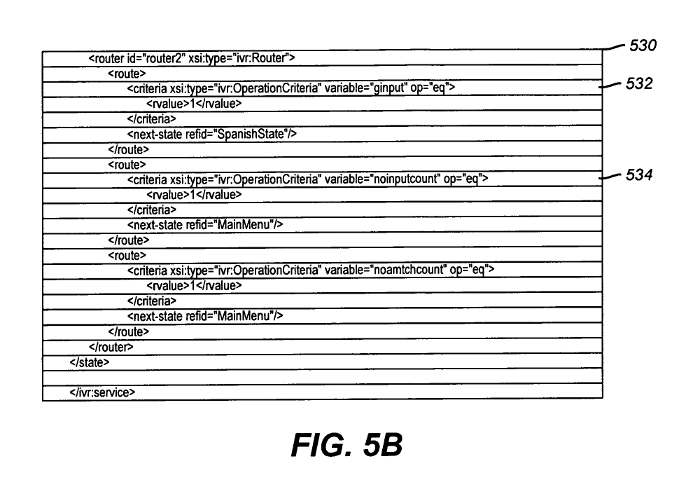

FIG. 5 shows software code 500 corresponding to the metalanguage entries in the software development screen 400 of FIG. 4. It can be seen from FIG. 4 and FIG. 5 that metalanguage hides the language specific implementation from the developer. The VWDF provides a meta-language, an example of which is shown in FIG. 4 for developing all the components of the application. Line 501 indicates a name of a state using the meta language: <state xsi:type=“ivr:State” id=“/Greeting”>. The name of the state in the code of line 501 is the same name 401 specified in the development screen 400. The software code 500 comprises a section of View Logic 510 and a section of Router Logic 530. View logic corresponds to prompts displayed in section 410 of FIG. 4. For example, the entry 414 in FIG. 4 related to callers from the western region (W) corresponds to the code section 514, FIG. 5 (shown in Table 1 below):

TABLE 1

```
<condition-prompt>
  <criteria xsi:type=“ivr:OperationCriteria”
  variable=“app.region_name” op=“eq”>
    <rvalue>W</rvalue>
  </criteria>
  <prompt xsi:type=“prompts:PromptRef” refid=“prompts.P_963”/>
</condition-prompt>
```

If a recognized app.region_name is equal to “W”, then prompts.P_{—}963 (“Welcome to 611 Repair Service. We know your time is valuable. Our automated system will isolate your trouble and initiate the repair process which will provide you with accurate and prompt service”) is presented to the user. Similarly, code 512 corresponds to prompt entry 412 for callers from Midwestern, Southwestern and Eastern regions. Section 530 displays Router logic for implementing business rules. Code section in Table 2 532 (shown of FIG. 5 below) shows a computer code section corresponding to branching condition 432 of FIG. 4:

```
TABLE 2
<route>
  <criteria xsi:type=“ivr:OperationCriteria” variable=“ginput” op=“eq”>
    <rvalue>1</rvalue>
  </criteria>
<next-state refid=“/SpanishState”/>
</route>
```

If ginput=1, (the user has pushed the “1” button) the ensuing dialog with the customer is performed in Spanish. Similarly, branching code 434 related to an invalid entry or lack of user response corresponds to line 534.

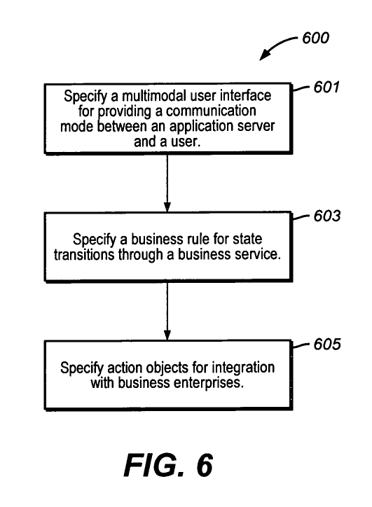

FIG. 6 illustrates a flowchart 600 of a method by which the VWDF provides a multimodal application. A multimodal interface is specified in Box 601 using View Logic. This code enables a user to interact with the application server over a variety communication modes, such as voice recognition, DTMF, text, etc. In Box 603, the VWDF establishes a set of business rules using Business Logic (e.g., Router Logic). These business rules enable state transitions through a business service by acting on a user input obtained through the multimodal user interface. In Box 605, the VWDF provides a set of action objects for integration with business enterprises. Integration with business enterprises enable information for completing a business transaction to be transmitted back and forth between user and business agent.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A computerized method for providing an application in a communication network, comprising:
a) receiving a first programmer input specifying a user interface for a user communication with the application; and
b) receiving a second programmer input specifying a business rule in the application that acts on a user input from the user interface.

2. The method of claim 1, further comprising:
receiving a third programmer input specifying an interaction between the application and an enterprise system.

3. The method of claim 1, wherein the user interface further comprises a view logic for a mutimodal communication mode.

4. The method of claim 3, wherein the multimodal communication mode further comprises at least one of the set consisting of a web browser and a cell phone.

5. The method of claim 1, wherein specifying further comprises using a metalanguage to indicate a code segment.

6. The method of claim 1, wherein the business rule provides at least one of the set consisting of a transition between states of a business service, and a transfer of information between the user and a database.

7. The method of claim 1, further comprising:
specifying a first communication mode for the user input and specifying a second communication mode for transmitting a response to the user.

8. A computer readable medium containing instructions that when executed by a computer perform a method for providing an application in a communication network, comprising:
a) receiving a first programmer input specifying a user interface for a user communication with the application; and
b) receiving a second programmer input specifying a business rule in the application that acts on a user input from the user interface.

9. The medium of claim 8 wherein method further comprises:
receiving a third programmer input specifying an interaction between the application and an enterprise system.

10. The medium of claim 8, wherein in the method the user interface further comprises a view logic for a mutimodal communication mode.

11. The medium of claim 10, wherein in the method the multimodal communication mode further comprises at least one of the set consisting of a web browser and a cell phone.

12. The medium of claim 8, wherein in the method specifying further comprises using a metalanguage to indicate a code segment.

13. The medium of claim 8 wherein in the method the business rule provides at least one of the set consisting of a transition between states of a business service, and a transfer of information between the user and a database.

14. The medium of claim 8, wherein the method further comprises:
specifying a first communication mode for the user input and specifying a second communication mode for transmitting a response to the user.

15. A set of application program interfaces embodied on a computer readable medium for execution on a computer in conjunction with an application program in a communication network comprising:
a) a first interface that receives a first programmer input specifying a user interface for a user communication with the application; and
b) a second interface that receives a second programmer input specifying a business rule in the application that acts on a user input from the user interface.

16. The set of application program interfaces of claim 15, further comprising:
a third interface that receives a third programmer input specifying an interaction between the application and an enterprise system.

17. The set of application program interfaces of claim 15, wherein the user interface further comprises a view logic for a mutimodal communication mode.

18. The set of application program interfaces of claim 17, wherein the multimodal communication mode further comprises at least one of the set consisting of a web browser and a cell phone.

19. The set of application program interfaces of claim 15, wherein specifying further comprises using a metalanguage to indicate a code segment.

20. The set of application program interfaces of claim 15, wherein the business rule provides at least one of the set consisting of a transition between states of a business service, and a transfer of information between the user and a database

21. The set of application program interfaces of claim 15, further comprising:
a fourth interface that receives a programmer input specifying a first communication mode for the user input and specifying a second communication mode for transmitting a response to the user.
